(19) United States
(12) Patent Application Publication
(10) Pub. No.: US 2025/0261218 A1
(43) Pub. Date: Aug. 14, 2025

(54) SYSTEMS AND METHODS FOR MANAGING LTE FALLBACK FOR WIRELESS DEVICES

(71) Applicant: T-Mobile Innovations LLC, Overland Park, KS (US)

(72) Inventor: Michael ROBERTS, Spring Hill, KS (US)

(21) Appl. No.: 18/441,365

(22) Filed: Feb. 14, 2024

(51) Int. Cl. H04W 72/51; H04W 28/02; H04W 36/06

(52) U.S. Cl. CPC H04W 72/51; H04W 28/0215; H04W 36/06

(57) ABSTRACT

Systems and methods are provided for managing LTE fallback for wireless devices. The methods include monitoring the temperature of a wireless device and determining that the wireless device is using a network slice. The methods further include transmitting a notification from the wireless device indicating the temperature of the wireless device and indicating parameters for the network slice in response to the temperature of the wireless device rising to meet a first temperature threshold. The methods further include establishing an LTE session for the wireless device in accordance with a performance profile for the wireless device based, at least in part, on the parameters for the network slice.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different radio access technologies (RATs). RATs can include, for example, 3G RATs (e.g., GSM, CDMA etc.), 4G RATs (e.g., WiMax, LTE, etc.), and 5G RATs (new radio (NR)). RATS may also include, for example, Wi-Fi and Bluetooth. Additionally, different standards may be implemented, including one or more International Engineering Task Force (IETF) standards; one or more of the Institute of Electrical and Electronics Engineers (IEEE) 802.11 standards; and/or any other industry standards and/or specifications. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to UEs.

5G deployments allow for network slicing. Network slicing allows a single network to be divided into multiple slices. Each slice can be configured and used in its own way. For example, a network slice may be established and configured for a Mobile Virtual Network Operator (MVNO) to lease from a larger cellular service provider to a small cellular service provider. As another example, network slices may be configured for different Quality of Service (QoS) levels such as a network slice for video streaming with its high bandwidth requirements and another for voice over IP (VOIP) with its low latency but lower bandwidth requirements. However, network slicing is not available for older networks such as LTE networks.

### OVERVIEW

Examples described herein include systems and methods for managing LTE fallback of wireless devices. An exemplary method includes monitoring a temperature of a wireless device. The method further includes determining that the wireless device is using a network slice. The method further includes transmitting a notification from the wireless device indicating the temperature of the wireless device and indicating parameters for the network slice responsive to the temperature of the wireless device rising to meet a first temperature threshold. The method further includes establishing an LTE session for the wireless device in accordance with a performance profile for the wireless device based, at least in part, on the parameters for the network slice.

Another exemplary embodiment includes a system including a Mobility Management Entity (MME). The MME includes at least one electronic processor configured to perform operations. The operations include receiving an indication that a wireless device has an operating temperature exceeding a first temperature threshold. The operations further include receiving an indication of one or more parameters of a network slice serving the wireless device. The operations further include setting a performance profile for the wireless device based, at least in part, on the one or more parameters of the network slice serving the wireless device. The operations further include establishing an LTE session for the wireless device in accordance with the performance profile.

Another exemplary method includes receiving at an MME from a wireless device, notification of a temperature of the wireless device exceeding a first temperature threshold. The method further includes receiving, at the MME from the wireless device, indication of one or more parameters of a network slice serving the wireless device. The method further includes setting, at the MME, a performance profile for the wireless device based, at least in part, on the one or more parameters for the network slice. The method further includes establishing an LTE session for the wireless device in accordance with the performance profile.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates an exemplary processing node in accordance with various aspects of the present disclosure;

FIG. 3 illustrates an exemplary process flow for managing LTE fallback for wireless devices; and

FIG. 4 illustrates an exemplary process flow for managing LTE fallback for wireless devices.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a 5G core network provides network slices to allow for many virtualized networks to be provided on the hardware architecture of the cellular network operator. One use of network slicing is to provide different levels of Quality of Service (QoS) depending on the needs of the wireless devices using the network slices and the needs of the network operator providing them. Network slices can be created and configured for many different levels of QoS. For example, a network slice for video streaming requires high bandwidth and low latency. As another example, a network slice for voice calls would require lower bandwidth and tolerate higher latency than video calls. Each network slice may be created with specific parameters. Some of these parameters control the QoS for the network slice. These parameters control things such as data rates, latency, reliability, and traffic prioritization. However, network slicing is not available for LTE connections. The LTE core network is not aware of network slices or their parameters.

LTE connections manage QoS differently. The parameters managing QoS for LTE connections include Guaranteed Bit Rate (GBR), priority handling, packet error loss rate, and packet delay budget (PDB). The parameters can be controlled individually or they can be managed within the QoS Class Identifier (QCI) scheme. The scheme defines a number of levels, each with its own settings for the QoS parameters. 3GPP defines a set of standard QCIs, but others are possible as well. Some of the standard QCIs are displayed below in Table 1. A device connecting to a 4G LTE network can request a specific QCI or the LTE core network can select a QCI for an LTE session. An LTE connection can be established with the specific individual parameters or the group of parameters corresponding to the specific QCI.

TABLE 1

| | | | | Packet | |
|---|---|---|---|---|---|
| | GBR | | | Error | |
| QCI | (Y/N?) | Priority | PDB | Loss Rate | Example Usage |
| 1 | GBR | 2 | 100 ms | 10⁻² | Voice calls |
| 2 | GBR | 4 | 150 ms | 10⁻³ | Video calls |
| 3 | GBR | 3 | 50 ms | 10⁻³ | Real time gaming |
| 4 | GBR | 5 | 300 ms | 10⁻⁶ | Video streaming |
| 5 | Non-GBR | 1 | 100 ms | 10⁻⁶ | IMS Signaling |
| 6 | Non-GBR | 6 | 300 ms | 10⁻⁶ | Web browsing, email |
| 7 | Non-GBR | 7 | 100 ms | 10⁻³ | Voice, video |
| | | | | | (live streaming), |
| | | | | | interactive gaming |
| 8 | Non-GBR | 8 | 300 ms | 10⁻⁶ | Video streaming, |
| | | | | | web browsing, email |
| 9 | Non-GBR | 9 | 300 ms | 10⁻⁶ | Video streaming, |
| | | | | | web browsing, email |

5G connections are more demanding on a wireless device than an LTE connection. 5G modems built into the wireless devices tend to get hot if they are being used heavily. LTE connections are less demanding and LTE modems tend to stay cooler. When a wireless device gets too hot, it can damage the device, including the device battery. An overheating battery can be a dangerous fire risk. Modern wireless devices have a protection mechanism where the device can fallback to an LTE connection if the device gets too hot. Some implementations of this mechanism will transition to LTE, dropping the 5G connection as soon as the temperature of the wireless device reaches the threshold. Other implementations of this mechanism have a two-stage system. At a first temperature threshold, the wireless device informs the provider network that its temperature is getting too hot, and it will soon transition to an LTE connection. At a second temperature threshold, higher than the first, the wireless device drops the 5G connection and transitions to the LTE connection. However, the LTE core network is not aware of network slicing and has no way of knowing if the wireless device is coming from using a network slice or has a higher-than-normal QoS requirement. This can result in a wireless device that requires a certain QoS being serviced at a much lower QoS significantly impacting user experience. For example, a wireless device using a network slice configured for streaming video could be migrated to a basic LTE connection with no QoS level defined. This could lead to a poor user experience as the basic LTE connection may not have sufficient bandwidth to stream the video without excessive buffering.

To alleviate this problem, the wireless device may inform the LTE core network, that it is currently using a network slice with specific parameters. For example, the wireless device may be using a network slice configured for video calling that has high bandwidth and low latency. When that wireless device informs the core network that it is getting hot and will soon migrate to an LTE connection, it can also indicate the QoS parameters of the network slice that it is currently using. The Mobility Management Entity (MME) of the LTE core network can use this information to create a performance profile for the LTE connection that it sets up for the wireless device. The MME can set parameters for packet scheduling, GBR and/or assign a specific QCI. For example, a GBR of 10 Mbps can be set or packets can be given a high priority for packet scheduling. Assigning a specific QCI can be done by selecting an appropriate QCI from the list of QCIs supported by the LTE network. The MME can be configured to analyze the QoS parameters from the wireless device and select a QCI that most closely approximates the QoS parameters assigned to the network slice servicing the wireless device. In the video call example above, the MME may choose to use QCI 2 as defined by 3GPP and discussed above, for example, and set the parameters for the LTE connection in accordance with the parameters outlined in QCI 2. The MME may establish the LTE connection and then wait for the wireless device to drop its 5G connection and connect to it.

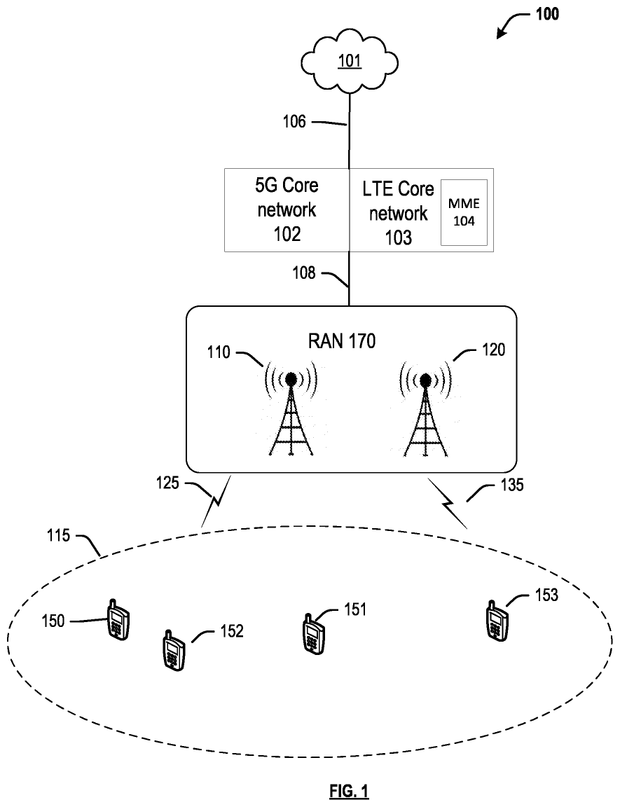

FIG. 1 depicts an exemplary system 100 for wireless communication, in accordance with the disclosed embodiments. The system 100 may include a communication network 101, 5G core network 102, LTE core network 103, and a radio access network (RAN) 170, including gNodeB access node 110 and eNodeB access node 120. The RAN 170 may include other devices and additional access nodes. Although the figure displays the gNodeB access node 110 and eNodeB access node 120 as separate devices, it is possible for a single device to perform the functions of an gNodeB and eNodeB. Access nodes may comprise two co-located cells, or antenna/transceiver combinations that are mounted on the same structure. Alternatively, access nodes may comprise a short range, low power, small-cell access node such as a microcell access node, a picocell access node, a femtocell access node, or a home eNodeB device.

Access nodes 110 and 120 can be configured to deploy at least two different carriers, each of which utilizes a different RAT. For example, a first carrier may be deployed by an access node in an LTE mode, and a second carrier may be deployed by an access node in an NR mode. Thus, in an embodiment, the access node may comprise two co-located cells, or antenna/transceiver combinations that are mounted on the same structure. In some embodiments, multiple access nodes may be deployed and each access node may support a different RAT. For example, a gNodeB may support NR and an eNodeB may provide LTE coverage. Any other combination of access nodes and carriers deployed therefrom may be evident to those having ordinary skill in the art in light of this disclosure.

Although two core networks 102 and 103 are shown, a single core network may be utilized that includes a distributed, cloud-native, converged core gateway instead of two distinct core networks. For example, the core networks 102 and 103 may be combined into a cloud native converged core network including both 5G and 4G. Thus, the converged core gateway could connect a 4G LTE evolved packet core (EPC) to a 5G core network. The LTE core network 103 includes a Mobility Management Entity (MME) 104.

The system 100 also includes multiple wireless devices 150-153, which may be end-user wireless devices and may operate within coverage area 115. The wireless devices 150-153 communicate with access nodes 110 and 120 within the RAN 170 over 5G NR communication link 125 and LTE communication link 135. While only a single 5G communication link and single LTE communication link are shown, it should be understood that any number of communication links may be present. Additionally, communication links other than 5G and LTE may be present. 5G NR communication link 125 may include the use of network slicing.

Communication links 106 and 108 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication links 106 and 108 can be direct links or might include various equipment, intermediate components, systems, and networks, such as a cell site router, etc. Communication links 106 and 108 may comprise many different signals sharing the same link.

Each of wireless devices 150-153 may be capable of simultaneously communicating with the RAN 170 using combinations of antennae via 4G and 5G or any other RAT or transmission mode, including multiple carriers. For instance, MU-MIMO pairings and SU-MIMO pairings can be made by wireless devices 150-153. It is noted that any number of access nodes, antennae, MU-MIMO pools, carriers, and wireless devices can be implemented. Wireless devices 150-153 may be any device, system, combination of devices, or other such communication platform capable of communicating on the wireless network using one or more frequency bands deployed therefrom.

The access nodes 110 and 120, MME 104, wireless devices 150-153 and other programmable components can comprise a processor and associated circuitry to execute or direct the execution of computer-readable instructions to perform operations such as those further described herein. These components can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

In operation MME 104 may be configured to perform a method including receiving from a wireless device 150-153 a notification of a temperature of the wireless device 150-153 exceeding a first temperature threshold. The method may further include receiving from the wireless device 150-153 an indication of one or more parameters of a network slice serving the wireless device 150-153. The method may further include setting a performance profile for the wireless device 150-153 based, at least in part, on the one or more parameters for the network slice. The method may further include establishing an LTE session using the LTE communication link 135 for the wireless device 150-153 in accordance with the performance profile. The method may further include receiving from the wireless device 150-153 notification that the temperature of the wireless device 150-153 has exceeded a second temperature threshold higher than the first temperature threshold and in response to such notification, migrating the wireless device 150-153 to the LTE session using the LTE communication link 135. The method may further include disconnecting the wireless device 150-153 from the 5G NR communication link 125, including the network slice serving the wireless device 150-153.

The performance profile can include parameters such as guaranteed bit rate (GBR), packet scheduling prioritization, PDB and packet error loss rate. The performance profile may be selected from a list of preexisting performance profiles such as the QCI profiles discussed above. The performance profile may be selected from the preexisting list to approximate the quality of service being provided by the network slice serving the wireless device 150-153. For example, if the network slice is configured to provide high bandwidth and low latency for something like real time gaming, QCI 3 as defined by the 3GPP and shown above in Table 1 may be selected for the performance profile and the LTE session may be established with the corresponding parameters for GBR, priority, PDB and packet error loss rate.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). System 100 may be capable of communicating signals and carrying data, for example, to support voice, push-to-talk, broadcast video, and data communications by end-user wireless devices 150-153. Wireless network protocols may include one or more of Multimedia Broadcast Multicast Services (MBMS), code division multiple access (CDMA) 1×RTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM).

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication system 100 may be, comprise, or include computers systems and/or processing nodes. This includes, but is not limited to the MME 104, access nodes 110 and 120, and wireless devices 150-153.

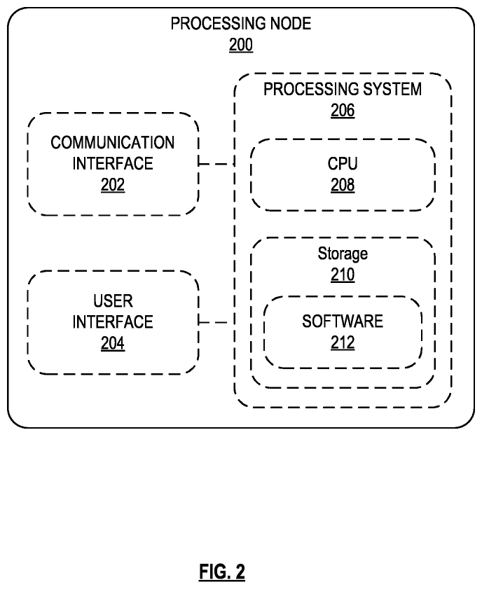

FIG. 2 depicts an exemplary processing node 200, which may be configured to perform the methods and operations disclosed herein to improve spectral efficiency. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200.

In an exemplary embodiment, software 212 can include instructions for receiving an indication that a wireless device has an operating temperature exceeding a first temperature threshold. The instructions may further include instructions for receiving an indication of one or more parameters of a network slice serving the wireless device. The instructions may further include instructions for setting a performance profile for the wireless device based, at least in part, on the one or more parameters of the network slice serving the wireless device. The instructions may further include instructions for establishing an LTE session for the wireless device in accordance with the performance profile. The instructions may further include instructions for receiving an indication that the wireless device has an operating temperature exceeding a second temperature threshold higher than the first temperature threshold and responsive to receiving that indication, migrating the wireless device to the LTE session.

The performance profile may include parameters such as guaranteed bit rate (GBR), packet scheduling prioritization, PDB and packet error loss rate. The performance profile may be selected from a list of preexisting performance profiles such as the QCI profiles discussed above. The performance profile may be selected from the preexisting list to approximate the quality of service being provided by the network slice serving the wireless device. For example, if the network slice is configured to provide high bandwidth and medium latency for something like video calls, QCI 2 as defined by the 3GPP and shown above in Table 1 may be selected for the performance profile and the LTE session may be established with the corresponding parameters for GBR, priority, PDB and packet error loss rate.

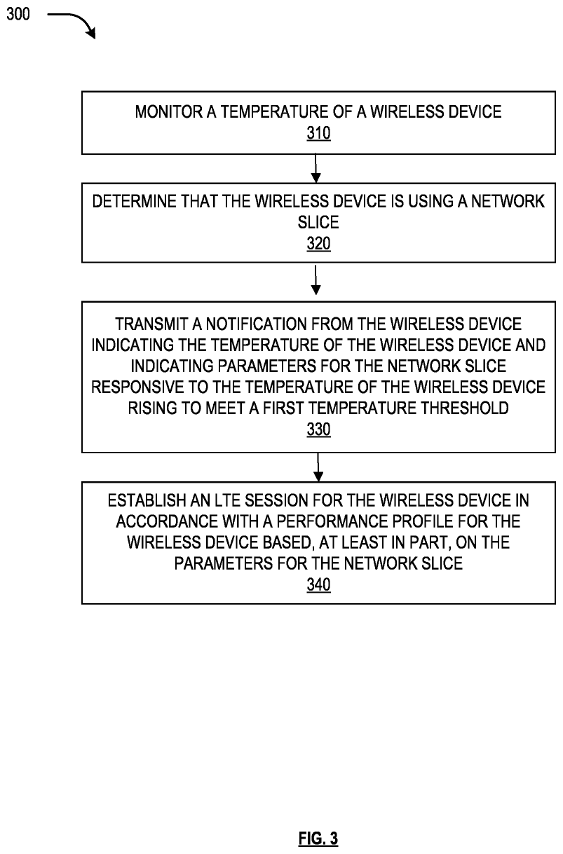

FIG. 3 illustrates an exemplary method 300 for managing LTE fallback of wireless devices. Method 300 can be implemented by any suitable combination of processors, such as processing node 200. Although FIG. 3 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 300 begins in step 310 where the temperature of a wireless device is monitored. Method 300 continues in step 320 where it is determined that the wireless device is using a network slice. Method 300 continues in step 330 where responsive to the temperature of the wireless device rising to meet a first temperature threshold, a notification from the wireless device is transmitted indicating the temperature of the wireless device and indicating the parameters of the network slice serving the wireless device. Method 300 continues in step 340 where an LTE session is established for the wireless device in accordance with a performance profile for the wireless device based, at least in part, on the parameters for the network slice. Method 300 may include optional steps. For example, the method may include migrating the wireless device to the LTE session responsive to the temperature of the wireless device rising to meet a second temperature threshold higher than the first temperature threshold. Another example includes an optional step of disconnecting the wireless device from the 5G connection including the network slice.

The performance profile may include parameters such as guaranteed bit rate (GBR), packet scheduling prioritization, PDB, and packet error loss rate. The performance profile may be selected from a list of preexisting performance profiles such as the QCI profiles discussed above. The performance profile may be selected from the preexisting list to approximate the quality of service being provided by the network slice serving the wireless device. For example, if the network slice is configured to provide high bandwidth and medium latency for something like video calls, QCI 2 as defined by the 3GPP and shown above in Table 1 may be selected for the performance profile and the LTE session may be established with the corresponding parameters for GBR, priority, PDB and packet error loss rate.

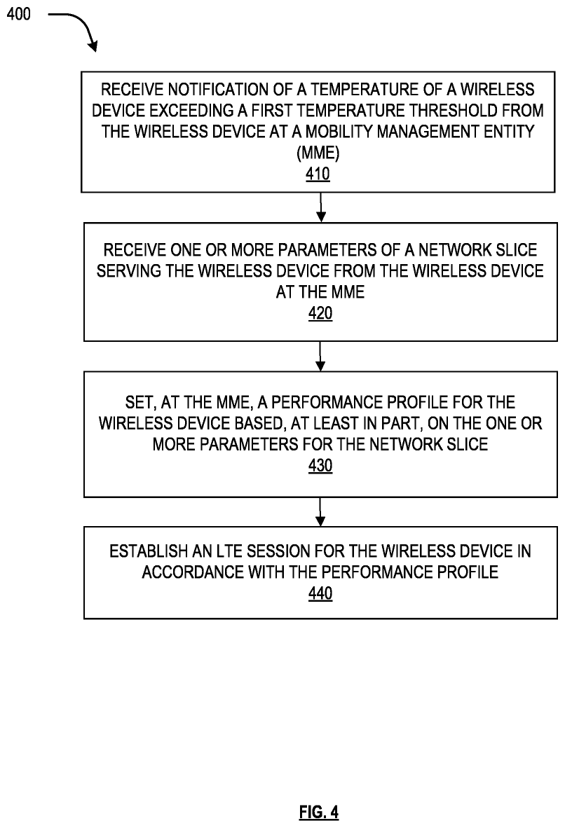

FIG. 4 illustrates an exemplary method 400 for managing LTE fallback of wireless devices. Method 400 can be implemented by any suitable combination of processors, such as processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where a notification from a wireless device of a temperature of the wireless device exceeding a first temperature threshold is received at the MME. Method 400 continues in step 420 where an indication of one or more parameters of a network slice serving the wireless device is received from the wireless device at the MME. Method 400 continues in step 430 where a performance profile for the wireless device based, at least in part, on the one or more parameters for the network slice is set at the MME. Method 400 continues at step 440 where an LTE session is established for the wireless device in accordance with the performance profile. Method 400 may include optional steps. For example, the method may include receiving, at the MME from the wireless device, notification of the temperature of the wireless device exceeding a second temperature threshold higher than the first temperature threshold and in response to receiving that notification, migrating the wireless device to the LTE. Another example includes an optional step of disconnecting the wireless device from the 5G connection including the network slice.

The performance profile may include parameters such as guaranteed bit rate (GBR), packet scheduling prioritization, PDB, and packet error loss rate. The performance profile may be selected from a list of preexisting performance profiles such as the QCI profiles discussed above. The performance profile may be selected from the preexisting list to approximate the quality of service being provided by the network slice serving the wireless device. For example, if the network slice is configured to provide medium bandwidth and latency for something like voice calls, QCI 1 as defined by the 3GPP and shown above in Table 1 may be selected for the performance profile and the LTE session may be established with the corresponding parameters for GBR, priority, PDB and packet error loss rate.

In some embodiments, methods 300 and 400 may include additional steps or operations. Furthermore, the methods may include steps shown in each of the other methods. As one of ordinary skill in the art would understand, the methods of 300 and 400 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of managing LTE fallback for a wireless device, the method comprising:
monitoring a temperature of the wireless device;
determining that the wireless device is using a network slice;
responsive to the temperature of the wireless device rising to meet a first temperature threshold, transmitting a notification from the wireless device indicating the temperature of the wireless device and indicating parameters for the network slice; and
establishing an LTE session for the wireless device in accordance with a performance profile for the wireless device based, at least in part, on the parameters for the network slice.

2. The method of claim 1, the method further comprising:
responsive to the temperature of the wireless device rising to meet a second temperature threshold higher than the first temperature threshold, migrating the wireless device to the LTE session.

3. The method of claim 2, wherein the method further comprises disconnecting the wireless device from the network slice.

4. The method of claim 1, wherein the performance profile comprises parameters for guaranteed bit rate.

5. The method of claim 1, wherein the performance profile comprises parameters for packet scheduling prioritization.

6. The method of claim 1, wherein the performance profile is selected from a list of preexisting candidate performance profiles.

7. The method of claim 6, wherein the performance profile is selected from the list of preexisting candidate performance profiles to approximate a quality of service provided by the network slice.

8. A system, the system comprising:
a Mobility Management Entity (MME) including at least one electronic processor configured to perform operations, the operations including:
receiving an indication that a wireless device has an operating temperature exceeding a first temperature threshold;
receiving one or more parameters of a network slice serving the wireless device;
setting a performance profile for the wireless device based, at least in part, on the one or more parameters of the network slice serving the wireless device; and
establishing an LTE session for the wireless device in accordance with the performance profile.

9. The system of claim 8, the operations further including:
receiving an indication that the operating temperature of the wireless device exceeds a second temperature threshold, higher than the first temperature threshold; and
responsive to receiving the indication that the operating temperature of the wireless device exceeds the second temperature threshold, migrating the wireless device to the LTE session.

10. The system of claim 8, wherein the performance profile comprises parameters for guaranteed bit rate.

11. The system of claim 8, wherein the performance profile comprises parameters for packet scheduling prioritization.

12. The system of claim 8, wherein the performance profile is selected from a list of preexisting candidate performance profiles.

13. The system of claim 12, wherein the performance profile is selected from the list of preexisting candidate performance profiles to approximate a quality of service provided by the network slice.

14. A method of managing LTE fallback for a wireless device, the method comprising:
receiving, at a Mobility Management Entity (MME) from a wireless device, notification of a temperature of the wireless device exceeding a first temperature threshold;
receiving, at the MME from the wireless device, one or more parameters of a network slice serving the wireless device;
setting, at the MME, a performance profile for the wireless device based, at least in part, on the one or more parameters of the network slice; and
establishing an LTE session for the wireless device in accordance with the performance profile.

15. The method of claim 14, the method further comprising:
receiving, at the MME from the wireless device, notification that the temperature of the wireless device exceeds a second temperature threshold, higher than the first temperature threshold; and
responsive to receiving notification that the temperature of the wireless device has exceeded the second temperature threshold, migrating the wireless device to the LTE session.

16. The method of claim 15, wherein the method further comprises disconnecting the wireless device from the network slice.

17. The method of claim 14, wherein the performance profile comprises parameters for guaranteed bit rate.

18. The method of claim 14, wherein the performance profile comprises parameters for packet scheduling prioritization.

19. The method of claim 14, wherein the performance profile is selected from a list of preexisting candidate performance profiles.

20. The method of claim 19, wherein the performance profile is selected from the list of preexisting candidate performance profiles to approximate a quality of service provided by the network slice.
